(19) United States
(12) Patent Application Publication
(10) Pub. No.: US 2019/0146445 A1
(43) Pub. Date: May 16, 2019

(54) METHOD AND CONTROL DEVICE FOR CONTROLLING AN APPLIANCE ON THE BASIS OF A MEDIA FILE, COMPUTER PROGRAM PRODUCT, AND BUILDING AUTOMATION SYSTEM

(71) Applicant: AIZO GROUP AG, Schlieren (CH)

(72) Inventor: Martin VESPER, Wuppertal (DE)

(73) Assignee: AZIO GROUP AG, Schlieren (CH)

(21) Appl. No.: 16/302,127

(22) PCT Filed: May 19, 2016
(86) PCT No.: PCT/EP2016/061196

§ 371 Date: Nov. 16, 2018

(51) Int. Cl. G05B 19/042

(52) U.S. Cl. CPC G05B 19/0426; G05B 2219/2642; G05B 2219/2613; G05B 2219/23249

(57) ABSTRACT

A method for controlling at least one appliance incorporated in a system by using a control device. The method comprising the steps of selecting and/or retrieving a media file by a user or the system, analysis of the media file and extracting the information relevant to the control from the media file, and transmitting control commands to the at least one appliance on the basis of the information extracted from the media file.

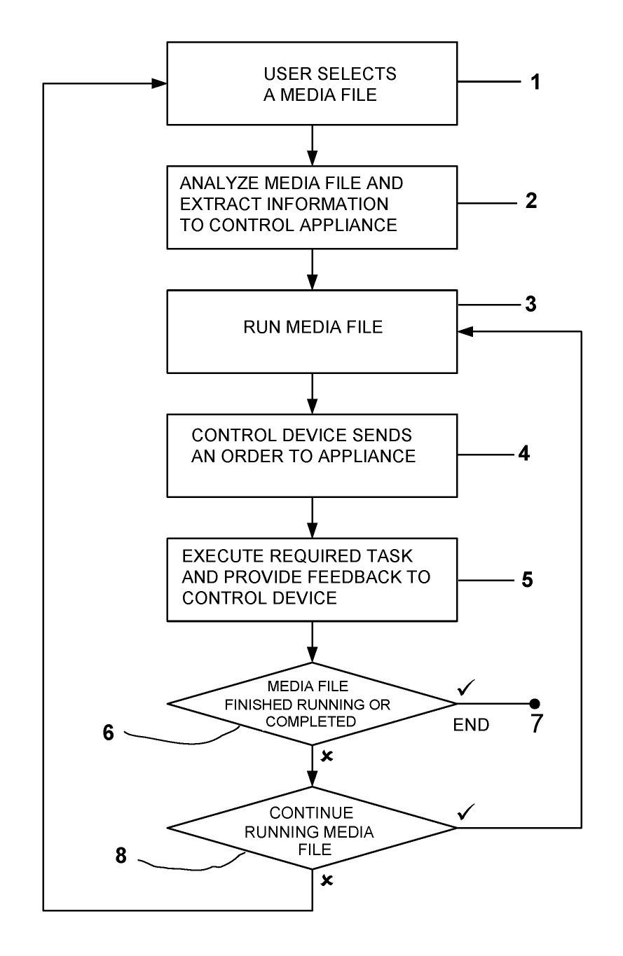

The present invention relates to a method and to a control device for controlling an appliance, incorporated into a system, on the basis of a media file, to a computer program product for evaluating the media file, and to a building automation system according to the preambles of the independent claims.

It is known from the prior art, on the basis of a video file played back on an appliance and containing additional information, to turn on connected appliances and/or to activate a corresponding preset program on the connected appliance.

One disadvantage of these systems is that the video file already has to be provided with the necessary additional information and the appliance to be controlled must already contain the program data required to control running. Accordingly, only the respectively predefined programs are able to be initiated using such videos or using the corresponding appliances.

The object of the invention is to overcome the disadvantages of the prior art. In particular, it is the intention to provide a method, a control device, a computer program product and a building automation system that are able to control an appliance as flexibly as possible on the basis of any desired media file.

This object is achieved by the methods and devices defined in the independent patent claims. Further embodiments become apparent from the dependent patent claims.

In the following description, the term “system” is understood to mean any type of electronic network in which a data transfer, in particular data exchange between the elements of the system, is made possible. This data transfer or data exchange may take place via a wired connection, a fiber-optic connection, optically, for example infrared, via radio or by way of PLC. By way of example, such a network may be a building automation system that networks various appliances with one another and allows them to be controlled in both a centralized and a decentralized manner.

A media file is understood to mean for example a video, a podcast, a live stream, a series of pictures, etc., which are not necessarily provided with specific control data for appliances.

A method according to the invention for controlling at least one appliance incorporated into a system, in particular a building automation system, using a control device, comprises the steps:
selection and/or retrieval of a media file by a user or by the system,
analysis of the media file and extraction of the information relevant for the control from the media file,
sending of control orders to the at least one appliance on the basis of the information extracted from the media file.

In this context, analysis of the media file is understood to mean that the context of the media file is recognized automatically and the content of the media file is evaluated accordingly. By way of example, such analysis is used to recognize spoken information regarding the oven temperature in a video guide for a cake recipe, and this information is extracted from the media file. The information obtained in this way may then be used further. Speech recognition algorithms, image recognition algorithms, gesture and facial expression recognition algorithms and/or further known algorithms are used for the analysis.

The information relevant for the control depends on the content of the media file and on the appliances to be controlled. By way of example, different information is extracted from a recipe for baking a cake than from a guide for installing a Sonos speaker or from a guided installation in a building where various control elements, such as for example dimmers and lamps, are correctly installed in a sequence and are flashed in order to test the system and/or buttons have to be pressed in order to confirm and/or test the installation.

Such a method makes it possible for example for the user to retrieve a media file on the Internet or from his private memory and to use this media file to directly actuate his appliances, which are for example incorporated in a building automation system. The user therefore no longer has to input the data required for the control in the building automation system himself, but rather said data are extracted automatically from the media file and the corresponding appliances are actuated. By way of example, a recipe for baking a cake is thus evaluated, the temperature required for baking is set in the oven, the mixer of the dough kneading machine is automatically activated and a timer in the oven is set to the corresponding baking time required for baking. The user only has to add the ingredients to the dough kneading machine, put the prepared dough into a baking mold and insert the baking mold in the oven. When inserting the dough into the oven and closing the oven door, the timer may be started automatically. Of course, fewer or further partial automations are also possible here.

The appliance may give the control device feedback that contains in particular information regarding the status of the appliance. Thus, for example, in the example described above, the dough kneading machine may report back to the control device when the dough has been sufficiently kneaded and a homogeneous mass has accordingly been produced. Such feedback may for example control the further running of the media file. In the case of the cake recipe, the user may be instructed to put the dough into the corresponding baking mold and to insert the baking mold containing the dough into the oven. It is likewise conceivable for such feedback from the oven to include for example the fact that the dough is now in the oven. Such feedback may be triggered by corresponding sensors in the appliance. The use of such feedback allows the corresponding information, which was extracted from the media file, to be processed efficiently.

Controlling the running of the media file may comprise one or combinations of the following steps:
stopping the running,
skipping the running forward to a particular point,
skipping the running back to a particular point,
interrupting the running,
continuing the running,
selecting and/or retrieving a further media file.

By influencing running of the media file, it can be ensured for example that instructions that are directed at the user and that are not executed are repeatedly output to the user in the form of an instruction. Likewise, in the abovementioned example, when closing the oven door after inserting the dough into the oven, it is necessary to interrupt running of the media file until the corresponding baking time has elapsed. It is furthermore also conceivable, however, for a further media file to be selected and/or retrieved on the basis of such feedback without the user activating further actions for this purpose. Thus, the system may recognize for example that the user is not acting in accordance with the instructions, and provide further explanatory media files.

The analysis of the media file may take place in real time. In the case of a video, it is therefore possible for the user to view the video and for the corresponding analyses to be performed in real time in the background. As mentioned previously, it is explained in the video for example that the oven has to be set at 200 degrees. This information is evaluated and transmitted directly to the oven. As an alternative, it is also conceivable, however, for the analysis of the media file to take place independently of the running of the media file. Such analysis independent of the running makes it possible for example, in the case of a video, for said video to already be completely analyzed before and/or during the running, such that possible skip positions are already recognized if need be.

To analyze the media file and to extract the information, audio data and/or video data and/or text data and/or additional information from the media file, such as for example metadata, tags, keywords, etc. may be evaluated. In particular, it is thus made possible for acoustic, visual and also additional information attached to the media file to be evaluated.

The control orders may be sent to the at least one appliance by way of the system, in particular a building automation system. Accordingly, the control device does not have to be connected or able to be connected directly to the appliances to be controlled, but only has to be able to communicate with its associated system. The at least one appliance to be controlled is already incorporated into this system, with the result that actuation is significantly simplified.

A further aspect of the present invention relates to a computer program product for evaluating a media file. A computer program product according to the invention for building automation, when it is executed on a computer, extracts information from a media file in order, on the basis of this extracted information, to be able to control at least one appliance in a system, in particular in a building automation system.

A computer program product is understood here for example to mean an app on a smartphone, a tablet computer, a notebook, etc. The computer is in this case accordingly understood also to be a smartphone, tablet computer, notebook, PC or cloud service. Accordingly, it is conceivable for the computer program product not to be executed on an appliance of the user, but for the corresponding media file to be loaded for example via an Internet connection in a cloud service and for the corresponding information to be extracted there. The extracted information for controlling the at least one appliance may then again be provided to the user or to the system via the Internet.

To extract the information, audio data and/or video data and/or text data and/or additional information from the media file may be evaluated. Again, it is thus made possible for the media file to be evaluated acoustically, visually, and also on the basis of its additional information, such as for example metadata, tags, keywords, etc.

A control device according to the invention, in particular for a method as outlined previously, for controlling at least one appliance incorporated into a system, in particular into a building automation system, comprises a media data interface, operator elements for a user for selecting and/or retrieving a media file, a display unit for displaying the selected media file, an analysis unit, in particular having a computer program product as described previously, for analyzing and extracting control information from the media file, and an interface to a system, in particular to a building automation system. A control device is understood in this case to mean for example a smartphone, a tablet computer, a notebook, a PC or a computer in any desired form, and network-attached storage (NAS), a router or a server. Likewise, a control device is also understood to mean a set top box, for example d-box, Dreambox, Mediabox, ReelBox, TiVo-PVR, AppleTV, Met@box, etc. or a video gaming console, for example SNES, PlayStation, Xbox, etc. The operator elements, the display unit and the analysis unit do not necessarily have to be integrated in the control device, but may be connected to the control device for example in a wired and/or wireless manner by way of a corresponding connection element.

A media data interface is constituted for example by a connection to a video jukebox, to a media player, to a memory, to a cloud service or a connection to the Internet. A media data interface is explicitly understood to mean not only a physical interface in the form of a plug connection or in the form of a wireless connection, but rather any data acquisition means, in particular a camera. This interface allows access to the selected and/or retrieved media file. A camera for example allows a user to photograph a conventional recipe from a book and to provide it to the control device for analysis.

An analysis unit is understood to mean an app or a program code that runs on the control device or if need be on a special chip of the control device. The analysis of the media file may also take place in a cloud service. This part of the cloud service would thus be the analysis unit, which is able to be incorporated by way of the connection means of the control device within the meaning of the present invention.

The term “interface to the system” should also not necessarily be considered to be a physical interface. In this case too, a wireless connection or else a connection via the Internet or a cloud service to the system is again conceivable.

Such a control device is capable for example of displaying a video file selected by the user and of analyzing it simultaneously and/or beforehand for information that may serve to control an appliance connected to the system or incorporated into this system.

The interface to the system may be configured unidirectionally or bidirectionally. In the case of a bidirectional configuration, it is possible for example for the appliance to be controlled to report back feedback, for example regarding its status, to the control device. Accordingly, the control device may for example stop, interrupt or continue playback of the media file, skip forward or back to a particular point or else retrieve a further media file.

The media data interface may comprise a connection to the Internet. Accordingly, the user may also select and/or retrieve the media file from the Internet, from a cloud service or from a streaming service.

A building automation system according to the invention comprises a computer program product as outlined previously and/or a control device as described previously. Such a building automation system makes it possible in particular for certain appliances incorporated into the building automation system to be controlled by the control device or by a computer program product as described depending on information extracted from a media file.

One possible exemplary embodiment of the invention is explained in more detail below with reference to a flowchart.

What is shown is a method according to the invention with reference to a flowchart using the example of a cake to be baked. In a first step 1, the user selects a media file that explains in steps how to bake a cake. To this end, the user tells the control device that he would like to bake a cake and what type of cake he would like to bake. This may be performed for example by way of a speech input. The control device then searches for a corresponding recipe via a media interface. It is also conceivable, however, for the user to input this information in a conventional manner via a keyboard or to provide the corresponding media file directly to the control device. Furthermore, the user may also input his input from a recipe book, for example by providing a photograph of the recipe to the control device.

In step 2, the control device will use its analysis unit to analyze the media file and extract the information required to control the appliances, for example an oven, a dough kneading machine and a scales, from the media file. Various algorithms such as text recognition, image recognition, speech recognition, gesture recognition, facial expression recognition, etc. are used for this analysis step.

In step 3, running of the media file is started. In the case of a media file in the form of an instruction video, the video is shown and started on the display unit. As soon as a task to be executed by the user arises or an appliance has actuated and has to execute a task, running of the media file or of the video is interrupted. In the example of the cake, the individual ingredients are listed and the user is asked to place a bowl on the scales and to add the appropriate amount of the required ingredients to the bowl.

In step 4, the control device will then send an order to the oven in order to preheat it to the required temperature.

In step 5, the required task is executed by the user or by the appliance and there is feedback to the control device. This feedback may be performed by the user or directly by the appliance. In the case of adding the ingredients, the scales reports the weight to the control device by itself.

The two steps 4 and 5 may also take place in reverse order, such that the feedback from an appliance triggers sending of an order to a further appliance.

The control device decides in step 6 whether the media file has finished running or, in the present case, whether the cake has finished baking. If the cake has finished baking, the method is ended at point 7.

If not, the control device checks, in step 8, whether it is still expedient to continue to run the media file.

Normally, it is expedient to continue, such that step 3 is again skipped back to and the media file is played back again until the next required task.

There then follows the instruction to the user that the bowl has to be dispensed into the dough kneading machine, whereupon said dough kneading machine uses the information extracted from the media file, for example speed and time, to stir the ingredients to form a dough. As soon as a homogeneous dough is achieved or the set time has elapsed, there is again feedback to the control device. The cake is not yet fully baked and it is expedient to continue. Step 3 is then skipped back to again.

The media file continues to be played back and the user is instructed that the dough has to be put into the baking mold. As soon as the user confirms the executed task, the two decisions 6, 8 and the return to step 3 take place again.

The control device allows the media file to continue running and instructs the user, as soon as the oven has been sufficiently preheated, to insert the baking mold into the oven. To this end, the oven is actuated such that it automatically opens the door and the user is able to insert the mold. The closing of the oven door is reported back by the oven, as is the report that the cake has been placed in the oven. Accordingly, step 3 is again switched to and the required baking time is transmitted to the oven.

If the user has erroneously not placed the filled baking mold into the oven, but has only closed the oven door, the oven may give feedback 5 to the control unit. It is checked whether running is still expedient. As this is the case, step 3 is again switched to and the sequence containing the instruction to insert the baking mold into the oven is again played back to the user. The oven door is opened, the user actually inserts the cake into the oven, closes the door, and the baking time is reset.

If the user takes completely the wrong action in a working step and continuing running is no longer expedient, step 1 is skipped to and the control device searches for and selects a media file for solving the problem. By way of example, the user may have added too much flour to the ingredients. Accordingly, a media file for using the amount of flour that has been added is searched for and selected.

1-14. (canceled)

15. A method for controlling at least one appliance incorporated into a system using a control device, the method comprising:
selecting and/or retrieving a media file by a user or the system,
analyzing the media file and extracting information relevant for the control from the media file, and
sending control orders to the at least one appliance on the basis of the information extracted from the media file.

16. The method according to claim 15, wherein the system is building automation system.

17. The method according to claim 15, wherein the appliance returns a feedback to the control device.

18. The method according to claim 17, wherein the feedback includes information regarding a status of the appliance.

19. The method according to claim 17, wherein the control device controls running of the media file on a basis of the feedback from the appliance.

20. The method according to claim 19, wherein controlling the running of the media file comprises one or combinations of the following:
stopping the running,
skipping the running forward to a particular point,
skipping the running backward to a particular point,
interrupting the running,
continuing the running, or
selecting and/or retrieving a further media file.

21. The method according to claim 15, wherein analyzing of the media file takes place substantially in real time.

22. The method according to claim 15, wherein analyzing of the media file takes place independently of the running of the media file.

23. The method according to claim 15, wherein audio data and/or video data and/or additional information are evaluated in order to analyze the media file and extract the information.

24. The method according to claim 15, wherein the control orders are sent to the at least one appliance by way of the system.

25. A computer program product for building automation that, when the computer program is executed on a computer, extracts information from a media file in order to be able to control, on a basis of the extracted information, at least one appliance in a system.

26. The computer program product according to claim 25, wherein the appliance is controlled by a method comprising:
selecting and/or retrieving a media file by a user or the system,
analyzing the media file and extracting information relevant for the control from the media file, and
sending control orders to the at least one appliance on the basis of the information extracted from the media file.

27. The computer program product according to claim 25, wherein the appliance to be controlled is an appliance in a building automation system.

28. The computer program product according to claim 25, wherein audio data and/or video data and/or additional information from the media file are evaluated in order to extract the information.

29. A control device for controlling at least one appliance incorporated into a system comprising a media data interface, operator elements or connection elements to an operator element for a user for selecting and/or retrieving a media file, a display unit or connection elements to the display unit for displaying the selected media file, an analysis unit or connection elements to an analysis unit, for analyzing and extracting control information from the media file, and an interface to a system.

30. The control device according to claim 29, wherein the control device controls the appliance according a method comprising:
selecting and/or retrieving a media file by a user or the system,
analyzing the media file and extracting information relevant for the control from the media file, and
sending control orders to the at least one appliance on the basis of the information extracted from the media file.

31. A control device according to claim 29 further comprising a computer program product for building automation that, when the computer program is executed on a computer, extracts information from a media file in order to be able to control, on a basis of the extracted information, at least one appliance in a system, and an interface to a system.

32. The control device according claim 29, wherein the interface to the system is configured one of unidirectionally or bidirectionally.

33. The control device according to claim 29, wherein the media data interface has a connection to the Internet.

34. A building automation system comprising a computer program product for building automation that, when the computer program is executed on a computer, extracts information from a media file in order to be able to control, on a basis of the extracted information, at least one appliance in a system and/or a control device according to claim 29.
